(19) United States
(12) Patent Application Publication
(10) Pub. No.: US 2026/0153873 A1
(43) Pub. Date: Jun. 4, 2026

(54) AUTOMATIC POOL CLEANING DEVICE, POOL WALL CLEANING METHOD FOR AUTOMATIC POOL CLEANING DEVICE, AND COMPUTER STORAGE MEDIUM

(71) Applicant: Shenzhen Aiper Intelligent Co., Ltd., Shenzhen (CN)

(72) Inventor: Zewen SUN, Shenzhen (CN)

(73) Assignee: Shenzhen Aiper Intelligent Co., Ltd., Shenzhen (CN)

(21) Appl. No.: 19/456,779

(22) Filed: Jan. 22, 2026

(30) Foreign Application Priority Data
Feb. 25, 2025 (CN) 2025102133383

(51) Int. Cl. G05D 1/622; E04H 4/16; G05D 1/648; G05D 105/10; G05D 107/00

(52) U.S. Cl. CPC G05D 1/622; E04H 4/1654; G05D 1/648; G05D 2105/10; G05D 2107/29

(57) ABSTRACT

The present application provides an automatic pool cleaning device, a pool wall cleaning method for the automatic pool cleaning device, and a non-transitory computer storage medium. The pool wall cleaning method includes: controlling the automatic pool cleaning device to move along a first path on a pool wall to a surface of a pool bottom, and retreat a first predetermined distance or a predetermined time on the surface of the pool bottom, and then turn by a first predetermined angle; and controlling the automatic pool cleaning device to move toward the pool wall along a second path after the automatic pool cleaning device turns by the first predetermined angle; wherein during movement of the automatic pool cleaning device along the second path, upon encountering an obstacle, the automatic pool cleaning device is capable of turning in a direction away from the first path.

### CROSS-REFERENCE TO RELATED APPLICATION

This application claims priority to Chinese Patent Application No. 202510213338.3, filed on Feb. 25, 2025, which is hereby incorporated by reference in its entirety.

### FIELD

The present application relates to the technical field of cleaning devices, and in particular, to an automatic pool cleaning device, a pool wall cleaning method for the automatic pool cleaning device and a computer storage medium.

### BACKGROUND

With the popularity of swimming pools and the significant progress of robot technology, more and more consumers are inclined to adopt automatic swimming pool cleaning robots to perform cleaning tasks on a swimming pool. When cleaning the pool wall of the swimming pool, the swimming pool cleaning robot needs to clean the pool wall sequentially in accordance with planned paths; and when the cleaning of a path is completed, it can switch to the next path to continue cleaning. In this way, each path can be cleaned one by one, so as to achieve a comprehensive cleaning of the entire pool wall. When the swimming pool cleaning robot switches from one path on the pool wall to another path to be cleaned, in a case where the path switching is performed at the pool bottom, it needs to move from the pool wall to the pool bottom, and after turning a small angle (for example, 25 degrees) on the pool bottom, move along the pool bottom and climb the pool wall to enter the other path to be cleaned. However, when the swimming pool cleaning robot encounters obstacles in the process of moving along the pool bottom, the distance-measuring module in front is affected by the obstacles, which will easily lead to the failure of the path switching, so that the swimming pool cleaning robot repeatedly cleans the same area or the same path on the pool wall after returning to the pool wall, thereby causing low cleaning efficiency and some areas to be missed during the cleaning.

### SUMMARY

For the shortcomings of the above-mentioned prior art, the present application provides a pool wall cleaning method for an automatic pool cleaning device, including: controlling the automatic pool cleaning device to move along a first path on a pool wall to a surface of a pool bottom, and retreat a first predetermined distance or a predetermined time on the surface of the pool bottom, and then turn by a first predetermined angle; and controlling the automatic pool cleaning device to move toward the pool wall along a second path after the automatic pool cleaning device turns by the first predetermined angle; wherein during movement of the automatic pool cleaning device along the second path, upon encountering an obstacle, the automatic pool cleaning device is capable of turning in a direction away from the first path.

Further, upon encountering the obstacle, the automatic pool cleaning device being capable of turning in the direction away from the first path includes: planning a third path, and controlling the automatic pool cleaning device to turn according to the third path.

Further, upon encountering the obstacle, the automatic pool cleaning device being capable of turning in the direction away from the first path includes: controlling the automatic pool cleaning device to contact the obstacle, so as to cause the automatic pool cleaning device to move away from the first path due to a contact force.

Further, the first path is a straight path.

Further, the first predetermined angle is between 50 and 100 degrees.

Further, the third path includes a sub-path extending in a direction close to the first path.

Further, the automatic pool cleaning device advances along a fourth path or retreats down the pool wall along the fourth path after climbing onto the pool wall, the first path is parallel to the fourth path, and a distance between the first path and the fourth path is greater than half a width of the automatic pool cleaning device.

Further, during the movement of the automatic pool cleaning device along the second path, recording a variation of a pitch angle; in a case where the variation of the pitch angle exceeds a preset threshold, after the automatic pool cleaning device retreats down the pool wall along the fourth path, controlling the automatic pool cleaning device to advance after turning it by a second predetermined angle; and the second predetermined angle is greater than the first predetermined angle.

Further, the second predetermined angle is 90 degrees.

The present application also discloses an automatic pool cleaning device is capable of performing the pool wall cleaning method described in any embodiment of the present application.

The present application also discloses a non-transitory computer storage medium having computer programs stored thereon, where the computer programs, when executed by a processor, implement the pool wall cleaning method described in any embodiment of the present application.

The embodiments described in the present application have the following beneficial effects: the pool wall cleaning method for the automatic pool cleaning device provided in the present application enables, during the cleaning of the pool wall, the robot to bypass obstacles when it encounters them at the pool bottom and continue to effectively clean the pool wall, so as to avoid the situation of repeatedly cleaning the same path due to the failure of switching paths after the robot encounters the obstacle, so that the robot can complete the cleaning task efficiently and without repetition, thereby enhancing the cleaning efficiency.

### BRIEF DESCRIPTION OF THE DRAWINGS

In order to more clearly illustrate technical solutions of the present application, a brief introduction will be made below to the accompanying drawings required for use in the description of the embodiments. The accompanying drawings described below are only exemplary embodiments of the present application.

FIG. 1 is a flow diagram showing a pool wall cleaning method for an automatic pool cleaning device in an embodiment of the present application.

FIG. 2 is a schematic diagram I showing a moving path for an automatic pool cleaning device in an embodiment of the present application.

FIG. 3 is a schematic diagram II showing a moving path for an automatic pool cleaning device in an embodiment of the present application.

### DETAILED DESCRIPTION OF EMBODIMENTS

The technical solutions in the present application will be clearly and completely described below. Obviously, the embodiments described are only partial embodiments in the present application and not all embodiments. Based on the embodiments in the present application, all other embodiments obtained by persons skilled in the art without creative labor shall fall within the protection scope of the present application. It should be illustrated that the embodiments in the present application and the features in the embodiments may be combined with each other without contradicting each other.

The present application provides a pool wall cleaning method 100 for an automatic pool cleaning device. The pool wall cleaning method 100 for the automatic pool cleaning device can be used to clean the pool wall of the pool. The pool is, for example, a pool-shaped building. The pool-shaped building may be a swimming pool, a water storage pool, a hydrotherapy pool, a water storage tank, a water storage tank, and so on. The automatic pool cleaning device may be a device such as an automatic cleaning device, a pool cleaning robot, and so on, which can clean the pool-shaped building. The present application does not limit the specific presentation mode of the automatic pool cleaning device and the pool-shaped building, as long as the principle of the present application can be realized. Hereinafter, the illustration is expanded with a robot as an example of the automatic pool cleaning device, and the swimming pool as an example of the pool or the pool-shaped building, unless otherwise specified. Hereinafter, the terms “a pool bottom”, “a bottom face of the swimming pool”, and “a bottom of the swimming pool” refer to a surface of the pool bottom in the swimming pool, unless otherwise specified. The terms “a pool wall” and “a surface of a pool wall” refer to a side wall of the pool, the side wall may be rectangular, curved or other shapes, and the pool wall and the pool bottom together form the main body of the pool.

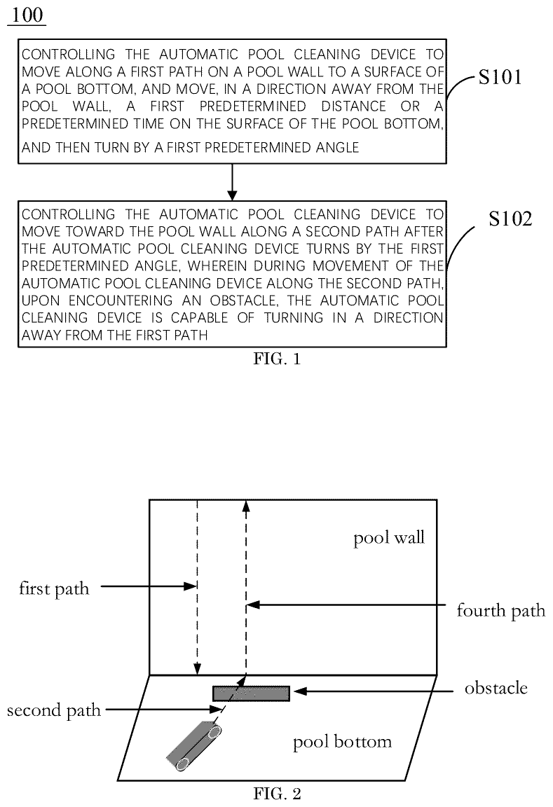

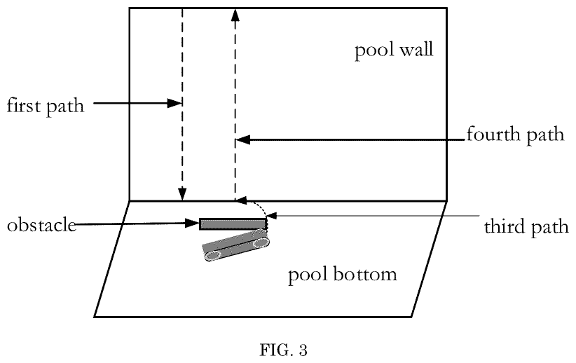

The pool wall cleaning method 100 of the present application will be illustrated in detail below in combination with the accompanying drawings. FIG. 1 is a flow diagram showing a pool wall cleaning method for an automatic pool cleaning device in an embodiment of the present application. FIG. 2 is a schematic diagram I showing a moving path for an automatic pool cleaning device in an embodiment of the present application. FIG. 3 is a schematic diagram II showing a moving path for an automatic pool cleaning device in an embodiment of the present application. As shown in FIG. 1, the pool wall cleaning method 100 includes steps S101 to S102. Steps S101 to S102 are illustrated below in conjunction with specific embodiments.

First of all, proceed to step S101. In step S101, controlling the automatic pool cleaning device to move along a first path on a pool wall to a surface of a pool bottom, and move, in a direction away from the pool wall, a first predetermined distance or a predetermined time on the surface of the pool bottom, and then turn by a first predetermined angle.

When the robot is performing cleaning operations in the pool, it can have three modes: a pool bottom cleaning mode, a pool wall cleaning mode and a water surface cleaning mode, where the pool wall cleaning mode is also known as a wall climbing mode, which mainly uses the principle of vacuum adhesion to attach the robot to the pool wall and move on the pool wall, so as to clean the pool wall of the swimming pool.

The first path is a cleaning path taken by the robot during its cleaning operations on the pool wall. The first path may be a path preset by the robot or a path randomly generated. For example, in the pool wall cleaning mode, multiple cleaning paths can be set on the pool wall to cover the entire pool wall, and the robot can perform the cleaning operations sequentially in accordance with the set cleaning paths, so as to achieve the comprehensive cleaning of the entire pool wall. It should be noted that in practice, the term “path planning” does not necessarily require the robot to plan a moving trajectory in advance and store the information corresponding to the moving trajectory in a memory of the robot. In the art, the so-called path planning usually refers to planning a movement rule. The movement rule may be a trajectory planned in accordance with the global map, or a certain movement rule for controlling the movement of the robot. During the cleaning operations performed on the pool wall, the robot moves in accordance with the movement rule, forming cleaning paths one after another and gradually completing the cleaning of the entire pool wall.

After completing one cleaning path, the robot needs to switch to the next path to be cleaned. The robot can turn and switch cleaning path by the lateral movement on the pool bottom, so as to achieve the path switching. The lateral movement of the robot on the pool bottom can be implemented by relying on a water pump and/or a driving device, for example, by changing the direction of the pump to drain water, the robot can be turned; by changing the wheel speed of the left and right wheels of the robot, the difference in wheel speed can be generated to cause the robot to turn.

As shown in FIG. 2, the robot moves along the first path on the pool wall toward the pool bottom and performs the cleaning until the cleaning task of the first path is completed, and then moves to the surface of the pool bottom. It can be understood that during the movement of the robot from the pool wall to the surface of the pool bottom, the direction pointed by the head of the robot can be taken as its direction of advancement, and alternatively, the direction pointed by the tail of the robot also can be taken as its direction of advancement. For example, when the robot moves along the first path, the head of the robot can be pointed in the direction of its advancement, that is, the head of the robot points downward towards the pool bottom; the tail of the robot can be pointed in the direction of its advancement, that is, the robot moves backward towards the pool bottom.

The first path may be a straight path. For example, the first path is perpendicular to the bottom face of the pool (the straight path), and each cleaning path may also be perpendicular to the bottom face of the pool, so that the robot can efficiently and accurately cover the entire pool wall area during cleaning operations. In addition, the first path is set as a straight path, which is convenient for the robot to maintain a constant or relatively constant direction and speed, and is beneficial to the stable operation of the robot during the cleaning tasks, and the control errors caused by the complexity of the path are reduced.

The movement of the robot from the pool wall to the surface of the pool bottom is not limited to the first path shown in FIG. 2. The robot can do path planning in advance to obtain moving path on the surface of the pool wall.

Next, proceed to step S102. In step S102, controlling the automatic pool cleaning device to move toward the pool wall along a second path after the automatic pool cleaning device turns by the first predetermined angle, wherein during movement of the automatic pool cleaning device along the second path, upon encountering an obstacle, the automatic pool cleaning device is capable of turning in a direction away from the first path.

The situation of the lateral movement of the robot on the pool bottom is illustrated below by referring to FIG. 2. As shown in FIG. 2, the first path and the fourth path are the paths to be cleaned on the pool wall, and the fourth path is an adjacent path to the first path, and the second path is the path along which the robot advances toward the fourth path after turning by a certain angle at the pool bottom. The robot moves along the first path on the pool wall and cleans it, then moves to the surface of the pool bottom, moves backward a certain distance (such as a first predetermined distance) or for a certain duration (such as a predetermined duration) on the surface of the pool bottom, and then turns by a certain angle (such as a first predetermined angle), then moves to the pool wall along the second path, and finally climbs onto the pool wall, and then cleans the wall along the fourth path. The robot moves along the path on the pool wall (such as the first path and the fourth path) on the surface of the pool wall, and inhales the impurities and dirt on the surface of the pool wall into a filter inside the robot through the water pump and a suction inlet disposed at the bottom of the robot, and filters these impurities and dirt and stores them in a dirt box, and discharges the water from a drain outlet, so as to achieve the purpose of cleaning the pool wall.

As described above, after controlling the robot to move from the pool wall to the surface of the pool bottom, in order to ensure that the robot has enough space when turning, so as to avoid the turning failure caused by insufficient space or the collision with the pool wall or other obstacles when it turns, the robot is first controlled to move in the direction away from the pool wall (such as moving backward) for the first predetermined distance (such as 0.5 body length), and the robot is then controlled to turn by the first predetermined angle (e.g. 55 degrees).

Similar to the above-mentioned principle, in order to ensure that the robot has enough space when turning, so as to avoid the turning failure caused by insufficient space or the collision with the pool wall or other obstacles when it turns, the robot can be controlled to retreat for a predetermined duration (for example, 5 seconds), during which the robot moves away from the pool wall (for example, moves backward) at a certain speed. Given the speed and predetermined duration of the robot, the distance traveled by the robot during this duration can be calculated.

After that, the robot is controlled to turn by the first predetermined angle. In the process of turning, the robot can monitor itself the changes in attitude and orientation angle in real time through a sensor (such as an Inertial Measurement Unit, IMU), so as to ensure the accuracy of the turning action. Once the predetermined angle has been reached, the robot stops turning and moves in the direction to which its head is currently pointing (i.e., the second path), and the head of the robot currently points toward the pool wall.

It can be understood that the sensor can monitor the robot′ attitude changes. The sensor, for example, is an inertial measurement unit (IMU), an angle sensor, a vision sensor, etc., provided that the technical principle of the present application can be realized.

The first predetermined angle is between 50-100 degrees. Depending on the first predetermined angle, when the robot moves along the second path at the pool bottom to the pool wall, the distance between the position of the pool wall pointed by its direction of advancement and the first path on the pool wall is different. It can be understood that if the first predetermined angle is large, the distance between the first path on the pool wall and the position where the robot reaches the pool wall in accordance with the second path is large, and correspondingly, the distance between the first path and the fourth path is large, and thus the cleaning effect of the pool wall may be affected by the large distance between the first path and the fourth path. If the first predetermined angle is small, the distance between the first path on the pool wall and the position where the robot reaches the pool wall in accordance with the second path is small, and correspondingly, the distance between the first path and the fourth path is small, and thus the cleaning effect of the pool wall is better. Therefore, preferably, the first predetermined angle is 55 degrees.

Taking the robot moving along the second path shown in FIG. 2 as an example, under normal circumstances (when there are no obstacles), the robot can move along the second path to the junction of the pool bottom and the pool wall (that is, the direction of the pool wall), and move on the pool wall along the fourth path. However, if the robot turns by a small angle (such as 25 degrees) on the pool bottom and encounters a low step or slope in the process of moving on the pool bottom, the robot may fail to change path on the pool wall, and even lead to a situation where the robot repeatedly cleans the same area or the same path on the pool wall. The two situations of “low step” and “slope” are respectively described below.

Taking the low step as an example, if the robot turns by a small angle on the pool bottom (for example, 25 degrees) and encounters the low step in the process of moving on the pool bottom, the low step blocks the advancement of the robot (for example, the low step jams the driving device of the robot), but a distance sensor of the robot is usually set on the upper or top of the robot, and this makes the distance sensor unable to sense the low step located near the driving device. However, the head of the robot contacts the low step at a certain small angle (such as 25 degrees) (that is, the “angle of entry” of the robot toward the low step is relatively large), the rotate speed of the driving device (e.g., driving wheel or track) on the side of the robot near the low step is reduced (or the driving device is stopped rotating). The driving device on the other side (e.g., drive wheel or track) is still rotating as usual, so that the head of the robot is perpendicular to the low step, and the robot continues to move to cross the low step, and then the robot moves to the surface of the pool wall. It can be seen that during its movement towards the pool wall, the robot does not move along the predetermined small angle (for example, 25 degrees) to the junction between the pool bottom and the pool wall, but the robot is affected by the low step and adjusted its moving direction midway (for example, after crossing the low step, the robot moves perpendicularly to the junction between the pool bottom and the pool wall). In other words, the position where the robot moves back to the pool wall is closer to the first path than the original position of moving along, for example, 25 degrees to the pool wall, resulting in the path switching failure of the robot on the pool wall, and even causing the robot to repeatedly clean the same area or the same path on the pool wall.

If the first predetermined angle is set to a large angle between 50 and 100 degrees, the robot can avoid the situation of failure to switch paths. Taking the robot moving along the second path shown in FIG. 2 as an example, if the robot encounters the low step in the process of moving along the pool bottom after turning by the large angle between 50-100 degrees (for example, 55 degrees), the head of the robot contacts the low step at a large angle (that is, the “angle of entry” of the robot toward the low step is relatively small), such that the left driving device of the robot can turns toward the direction away from the first path shown in FIG. 2 and then move forward along the side of the low step (for example, the length direction of the low step) (for example, as shown in FIG. 2, the left driving device of the robot abuts against the low step while the robot moves along the length direction of the low step, or, a state similar to being “bounced away” by this low step is generated). After the robot continues to move forward along the length direction of the low step and crosses the low step, since the robot has moved a certain distance along the length direction of the low step, thus the current position of the robot is away from the previous cleaning path on the pool wall (such as the first path shown in FIG. 2) in some extent. At this time, the robot has crossed the low step, and thus the movement of the robot towards the pool wall is no longer blocked by the low step. The robot can move to the junction of the fourth path and the pool bottom (for example, move along the third path as shown in FIG. 3 to the junction of the fourth path and the pool bottom), thereby avoiding the path switching failure of the robot on the pool wall caused by the low step.

Taking the slope on the pool bottom as an example, if there is a slope at the pool bottom of the swimming pool (for example, there is a slope in the transition area between the pool bottom and the pool wall), and the robot turns by a small angle (for example, 25 degrees) on the pool bottom, then the robot moves towards the slope. As the robot gradually moves up the slope, the pitch angle of the robot will gradually increase, which will easily cause the robot to slip on the surface of the slope and even slide down the slope. Since the robot previously turned by a small angle, the distance between the position of the robot when it slips or slides on the surface of the slope and the position of the robot when it turns is relatively close. After that, the robot will re-adjust the direction so that the head of the robot is perpendicular or nearly perpendicular to the pool wall, and then the robot moves forward and returns to the pool wall. It can be understood that at this time, the position of the robot on the pool wall is closer to the first path than the position of the robot when it moves to the pool wall without encountering the slope, which leads to the path switching failure of the robot on the pool wall, and even causes the robot to repeatedly clean the same area or the same path on the pool wall.

When the robot turns by a large angle of 50-100 degrees (such as 55 degrees) on the pool bottom and encounters the same slope as described above in the process of moving along the second path on the pool bottom, with the increase of the pitch angle of the robot, the robot will also slip on the surface of the slope or even slide down the slope. However, since the robot previously turned by a large angle, the body of the robot will slip or slide in a direction parallel to the pool wall (that is, the robot will turn away from the first path shown in FIG. 2) when the robot slips or even slides. After that, the robot will continue to move forward, so that the robot is gradually away from the first path in a direction parallel to or roughly parallel to the pool wall. After that, the robot will re-adjust the direction so that the head of the robot is perpendicular or nearly perpendicular to the pool wall, and then the robot moves forward and returns to the pool wall, or the robot moves forward until it bypasses the slope, and then the robot moves along the replanned path to the junction between the pool bottom and the pool wall (for example, along the third path shown in FIG. 3 to the junction between the fourth path and the pool bottom). In this way, the robot can avoid the situation of path switching failure on the pool wall due to the slope.

It can be understood that the first predetermined distance, the predetermined duration, the first predetermined angle, and the moving speed can be set by a user or at the time that the robot leaves the factory. The predetermined duration and the moving speed can also be set according to the size of the pool, the size of the robot, and other parameters.

The above description of the first predetermined distance of the retreat, the predetermined duration of the retreat, and the first predetermined angle of the turning is exemplary. The robot can move in the direction pointed by its tail (that is, retreat). Alternatively, the robot can move in the direction pointed by its head after turning 180 degrees, and the “retreat” effect described above can also be achieved. Persons skilled in the art may set the above terms and operations according to the actual needs, as long as the technical principles of the present application can be realized.

In step S102, upon encountering an obstacle, the automatic pool cleaning device being capable of turning in a direction away from the first path includes: controlling the automatic pool cleaning device to contact with the obstacle, so as to cause the automatic pool cleaning device to move away from the first path due to a contact force. For example, if the robot contacts with the obstacle in the process of moving along the second path (such as the second path in FIG. 2) after turning by 55 degrees on the pool bottom, the contact will produce the contact force (that is, an interaction force between the robot and the obstacle). At this time, a control module of the robot will send an instruction to keep the robot moving forward. However, due to the obstruction of the low step, the rotating speed of the driving wheel on one side of the robot is reduced (or the driving wheel does not turn), and the driving wheel on the other side is accelerated, so that there is a contact force between the robot and the obstacle, and because the angle between the robot and the obstacle is relatively large, the contact force will make the robot turn in the direction away from the first path.

In step S102, upon encountering the obstacle, the automatic pool cleaning device being capable of turning in the direction away from the first path includes: planning a third path, and controlling the automatic pool cleaning device to turn in accordance with the third path.

Referring to FIG. 3, the first path and fourth path in FIG. 3 are the cleaning paths on the pool wall, and the third path is the moving path for the robot to avoid the obstacle. As described above, if the robot encounters the low step or the slope in the process of moving towards along the second path, the robot will “bypass” the low step or slope as described above, after which the robot moves along the planned third path (such as the third path shown in FIG. 3) to the junction of the fourth path and the pool bottom. In the process of moving along the third path, the robot can monitor and adjust itself the changes in attitude and direction angle in real time through the sensor (such as the inertial measurement Unit, IMU) to ensure that the robot moves along the third path.

It can use the path planning algorithm to generate the third path based on the detected obstacle information (such as the location, shape, and size of the obstacle). The third path is able to guide the robot to “bypass” the obstacle and move towards the next path to be cleared on the pool wall (e.g., the fourth path in FIG. 3). Specifically, when moving along the third path, the robot will continuously calculate the relationship between its current position and direction angle and the position of the fourth path. The robot obtains its own information about real-time attitude, including the pitch angle and the direction angle, through the IMU. Then the current position and direction angle are calculated accurately by combining the preset path data, so as to determine the position and direction deviation of the robot relative to the fourth path.

In step S102, the third path includes a sub-path extending in a direction close to the first path. For example, during its movement along the third path, the robot can realize the turning of the body by changing the difference in speed between the left and right driving wheels of the robot. For example, when the turning speed of the left driving wheel is lower than that of the right driving wheel, the body will gradually deflect to the left. The deflection action enables the robot to adjust the direction pointed by its head so that its head points to the first path or roughly points to the first path, and then the moving path of the robot along the direction pointed by its head is the sub-path extending in a direction close to the first path described above. The sub-path is a phased and segmented moving track in the first path. The third path may be composed of multiple sub-paths. Each sub-path has a specific start point and end point, and the start point and end point of each sub-path are successively connected together to form a complete third path. In other words, during the movement of the robot along the third path, its direction angle can be adjusted multiple times, and after each adjustment of the direction angle, a segment of distance for which the robot moves forward can be called a sub-path.

It can be understood that controlling the robot to turn in accordance with the third path is implemented mainly by relying on the propulsion force generated by the driving device (e.g., driving wheel, track) of the robot and the propulsion force generated by the drainage of the water pump. The present application does not make specific restrictions on the way to control the steering of the robot, as long as the technical principle of the present application can be realized.

In step S102, the automatic pool cleaning device advances along a fourth path or retreats down the pool wall along the fourth path after climbing onto the pool wall, the first path is parallel to the fourth path, and a distance between the first path and the fourth path is greater than half a width of the automatic pool cleaning device.

For example, the robot advances or retreats along a fourth path (e.g., the fourth path in FIG. 3). That is, the head of the robot is moving up towards the water line of the pool wall, or the tail of the robot is pointing in the direction of its advance, that is, the robot retreats from the water line of the pool wall to the surface of the pool bottom.

Referring to FIG. 3, the first path and the fourth path remain parallel in space, and the distance between the first path and the fourth path is greater than half the width of the robot's body. In other words, the parallel and reasonably spaced setting of those paths, e.g., the first path and the fourth path, on the pool wall can cover all areas of the pool wall to ensure the comprehensiveness and efficiency of cleaning the pool wall.

In step S102, during the movement of the automatic pool cleaning device along the second path, recording a variation of a pitch angle; in a case where the variation of the pitch angle exceeds a preset threshold, after the automatic pool cleaning device retreats down the pool wall along the fourth path, controlling the automatic pool cleaning device to advance after turning it by a second predetermined angle; and the second predetermined angle is greater than the first predetermined angle.

For example, during the robot's movement along the second path, the variation of the pitch angle of the robot is obtained by the Inertial Measurement Unit (IMU). The IMU is an inertial sensor module that measures the motion state of an object, including an accelerometer, a gyroscope, and a magnetometer. The accelerometer is used to measure the acceleration of the robot in three-dimensional space. The acceleration includes the gravitational acceleration due to the action from the gravity of the earth and the inertial acceleration caused by the change in the motion state of the object. The gyroscope is used to measure the angular velocity of the robot in three-dimensional space, that is, the rate at which the robot rotates around the various spatial axes (X, Y, and Z). The magnetometer is used to detect the magnetic field of the environment around the robot when it performs cleaning tasks, helping to determine the orientation of the robot in an earth coordinate system. Through these data, the moving trajectory and change in position of the robot can be calculated. Specifically, when the robot moves along the second path, the IMU continuously collects the data of its acceleration and angular velocity. When the robot moves along the second path without encountering the obstacle, its acceleration is mainly along the advance direction. However, when the robot encounters the obstacle in the process of moving along the second path, its angular velocity will increase significantly, and the variation in the pitch angle can be calculated by measuring the change in the angular velocity, so that the variation in the pitch angle can be obtained.

It should be noted that due to the noise and error in the measured readings of IMU, the collected data needs to be fused and filtered. Commonly used methods include, but are not limited to, Kalman filtering, complementary filtering, etc., to improve the accuracy and stability of the data.

It should be noted that since the meter for wheel speed may have cumulative errors (e.g., wheel slippage, tire wear, etc.), it needs to be corrected periodically. Positioning accuracy can be improved by data fusion with other sensors (e.g., an IMU, a distance-detecting sensor, a magnetometer, etc.).

If the variation in the pitch angle exceeds a preset threshold, after the automatic pool cleaning device descends from the pool wall in accordance with the fourth path, the automatic pool cleaning device is controlled to advance after turning by a second predetermined angle; and the second predetermined angle is greater than the first predetermined angle. For example, if the robot encounters a slope in the process of advancing along the second path, and the variation in the pitch angle of the robot calculated by the inertial measurement unit exceeds the preset threshold (e.g., 45 degrees), it is indicated that the slope is relatively steep. After turning by the first predetermined angle, the robot still “slips” in the climbing process, resulting in the robot repeatedly cleaning the same area or the same path on the pool wall, but it does not enter the planned next path to be cleaned. Therefore, it is necessary to control the turning angle of the robot again to be greater than the first predetermined angle. By turning a larger angle, the robot can bypass the slope and enter the next path to be cleaned.

For example, the second predetermined angle is 90 degrees. For example, in the process of advancing along the second predetermined path, if the robot encounters an obstacle, the obstacle can be effectively avoided by controlling the robot to turn a large angle of 90 degrees, so that the robot can escape from the current predicament and enter the next planned path to be cleared. It can be understood that the setting of the second predetermined angle is only an example, and persons skilled in the art can set the second predetermined angle according to actual needs, as long as the technical principles of the present application can be realized.

The above description of the moving path of the robot with reference to FIG. 2 and FIG. 3 is only exemplary. Persons skilled in the art can set the moving path of the robot according to the above description, as long as the technical principle of the present application can be realized.

It should be noted that the robot can use the path planning algorithm to obtain the first path, the second path, the third path, and the fourth path, and can also obtain individual paths by updating and iterating the historical cleaning paths. The path may also be provided or set by the user; the path may also be pre-stored in the memory of the robot. The above description of the manner in which the path is obtained is only exemplary. Persons skilled in the art can select the path according to the actual situation, provided that the technical principles of the present application can be realized.

The pool wall cleaning method 100 for the automatic pool cleaning device provided in the present application enables, during the cleaning of the pool wall by the robot, the robot may avoid obstacles when it encounters them at the pool bottom and continue to effectively clean the pool wall, so as to avoid the situation of repeatedly cleaning the same path due to the failure of switching paths after the robot encounters the obstacles, so that the robot can complete the cleaning task efficiently and without repetition, thereby enhancing the cleaning efficiency.

The present application also provides an automatic pool cleaning device, and the automatic pool cleaning device can perform to implement the pool wall cleaning method described by the forgoing embodiment(s).

The present application discloses a computer storage medium having computer programs stored thereon, and the computer programs, when executed by a processor, implement the above-mentioned pool wall cleaning method.

It should be understood that in the present embodiment, the above-mentioned computer storage medium may be located on at least one network server in the multiple network servers of the computer network. Optionally, in the present embodiment, the above-mentioned computer storage medium may include, but is not limited to, various medium capable of storing the program code, such as USB flash drive, Read Only Memory (ROM), Random Access Memory (RAM), portable hard disk, magnetic disk, or optical disc.

It should be illustrated that the above order of embodiments in the present application is only for description and does not represent the merits of embodiments.

In the description of the present specification, the reference terms “an embodiment”, “some embodiments”, “examples”, “specific examples”, or “some examples”, etc., refer to that the specific features, structures, materials, or characteristics described in combination with this embodiment or example are included in at least one embodiment or example of the present application. Further, the specific features, structures, materials or characteristics described may be combined in a suitable manner in any one or more of embodiments or examples. In addition, without contradicting each other, persons skilled in the art may combine and assemble the different embodiments or examples and the features of different embodiments or examples described in the present specification.

Moreover, the terms “first” and “second” are only used to described purposes and are not to be understood as indicating or implying relative importance or as implicitly indicating the quantity of technical features indicated. In view of this, a feature defined as “first” or “second” may explicitly or implicitly include at least one feature. In the description of the present application, “multiple” means two or more, unless otherwise expressly and specifically defined.

In the present application, without the opposite explanation, the used positional words such as “up and down” are in terms of the directions shown in the accompanying drawings, or the vertical, perpendicular or gravitational directions; similarly, for the convenience of understanding and description, “left and right” usually refers to the left and right shown in the accompanying drawings; “inside and outside” refers to the inside and outside relative to the outline of each part itself. However, the positional words above described are not used to limit the present application.

The contents described above are only exemplary implementations of the present application, and cannot be used to limit the protection scope of the present application. In technical scope recorded in the present application, persons skilled in the art can easily think of various changes or replacements thereof, which all shall be covered within the protection scope of the present application. Therefore, the protection scope of the present application shall be governed by the protection scope of claims.

I/We claim:

1. A pool wall cleaning method for an automatic pool cleaning device, comprising:
controlling the automatic pool cleaning device to move along a first path on a pool wall to a surface of a pool bottom, and retreat a first predetermined distance or a predetermined time on the surface of the pool bottom, and then turn by a first predetermined angle; and
controlling the automatic pool cleaning device to move toward the pool wall along a second path after the automatic pool cleaning device turns by the first predetermined angle;
wherein during movement of the automatic pool cleaning device along the second path, upon encountering an obstacle, the automatic pool cleaning device is capable of turning in a direction away from the first path.

2. The pool wall cleaning method of claim 1, wherein upon encountering the obstacle, the automatic pool cleaning device being capable of turning in the direction away from the first path comprises:
planning a third path, and controlling the automatic pool cleaning device to turn according to the third path.

3. The pool wall cleaning method of claim 1, wherein upon encountering the obstacle, the automatic pool cleaning device being capable of turning in the direction away from the first path comprises:
controlling the automatic pool cleaning device to contact the obstacle, so as to cause the automatic pool cleaning device to move away from the first path due to a contact force.

4. The pool wall cleaning method of claim 1, wherein the first path is a straight path.

5. The pool wall cleaning method of claim 1, wherein the first predetermined angle is between 50 and 100 degrees.

6. The pool wall cleaning method of claim 1, wherein the third path comprises a sub-path extending in a direction close to the first path.

7. The pool wall cleaning method of claim 1, wherein the automatic pool cleaning device advances along a fourth path or retreats down the pool wall along the fourth path after climbing onto the pool wall, the first path is parallel to the fourth path, and a distance between the first path and the fourth path is greater than half a width of the automatic pool cleaning device.

8. The pool wall cleaning method of claim 7, wherein during the movement of the automatic pool cleaning device along the second path, recording a variation of a pitch angle; in a case where the variation of the pitch angle exceeds a preset threshold, after the automatic pool cleaning device retreats down the pool wall along the fourth path, controlling the automatic pool cleaning device to advance after turning it by a second predetermined angle; and the second predetermined angle is greater than the first predetermined angle.

9. The pool wall cleaning method of claim 8, wherein the second predetermined angle is 90 degrees.

10. An automatic pool cleaning device, wherein the automatic pool cleaning device is capable of performing the pool wall cleaning method of claim 1.

11. A non-transitory computer storage medium having computer programs stored thereon, wherein the computer programs, when executed by a processor, implement the pool wall cleaning method of claim 1.
